(19) United States
(12) Patent Application Publication
(10) Pub. No.: US 2010/0178913 A1
(43) Pub. Date: Jul. 15, 2010

(54) Low power apparatus for preventing loss of cell phone and other high value items

(75) Inventors: Christopher Gary Herbert, Carlsbad, CA (US); Tyler Rivera Crain, San Diego, CA (US); Christian Johan Smith, Carpinteria, CA (US)

Correspondence Address: MARK RODGERS, 1590 SAN ROQUE ROAD, SANTA BARBARA, CA, 93105, US

(73) Assignee: Drake Security

(21) Appl. No.: 12/319,891

(22) Filed: Jan. 12, 2009

(51) Int. Cl. H04W 4/00; G08B 13/14

(52) U.S. Cl. 455/426.1; 340/568.1

(57) ABSTRACT

A system for the prevention of loss of wallets, keys, purses and the like. The system uses a programmable wireless appliance such as a cell phone as a wireless tracker, and utilizes lightweight wireless tag devices attached to the items to protected. A software application executes on the wireless appliance to query the wireless tags and determines when any part of the system is going out of range.

### SEQUENCE LISTING

Not applicable

### FEDERALLY SPONSORED RESEARCH

Not applicable

### BACKGROUND OF THE INVENTION

The present invention relates to a small device that uses a radio communication terminal that is capable of communicating using a Ultra Low Power (ULP) Bluetooth protocol, or other wireless protocol, and more particularly utilizing the ULP Bluetooth communication protocol to connect to a cell phone and prevent the loss of the cell phone or item the device is associated with.

Mobile telephones have evolved to be an essential item that most people carry along with their keys and wallets or purses. Mobile phones have also evolved to run multiple applications and contain critical information, such that the loss of a phone can be as or more detrimental as losing one's wallet or keys. Currently, preventative solutions for protecting all one's critical it, such as wallets, purses, keys, or mobile phones, are either ineffective or cumbersome to use.

One current method of recovering phones uses GPS tracking. Although GPS can successfully locate the position of the phone, GPS tracking is not a preventative solution and offers no solution for protecting one's wallet, keys, or other items.

U.S. Pat. No. 6,885,848 by John-Gy Lee discloses an apparatus that prevents phone loss by establishing a Bluetooth connection between an audio headset and mobile phone. When the phone becomes more than a user defined distance separated from the headset, the headset rings and alert the user he/she is about to lose his/her phone. This method does not protect users' wallets, keys, or other items. This method also consumes a large amount of power due to the need for a calling state to be established and the use of conventional Bluetooth. The method also, requires the user to be using a wireless headset.

U.S. Pat. No. 7,002,473 by Larry D. Glick discloses a loss prevention system that comprises of a base monitoring unit and articles marked by RFID tags. The base unit periodically interrogates the marked items and alerts the user if the marker does not reply or is out of range. This solution requires the user to carry an extra device.

US Pat. Application No. US2007/0042714 by Mourad Ben Ayed discloses a portable loss prevention system that uses a base unit Bluetooth transceiver that automatically detects Bluetooth devices in the vicinity. On detected movement, the device checks for devices again and if a device that was detected before is not present, the base unit will alert the user that their device is gone. Although this approach is able to track and detect mobile phones as well as keys, wallets, etc., it is bulky, uses excessive battery, and requires the user to carry an extra device.

There is a need for a simple, low power system that does not require the user to carry an additional item to and is conveniently applicable to prevent the loss of high valued items such as cell phones, wallets, keys, etc.

### SUMMARY OF INVENTION

The invention is a system for preventing loss of personal belongings which includes a device containing a radio chip, battery, and program storage; an application adapted to execute on the device, such that whenever the application receives a query over the radio it responds; and an application adapted to execute on a cell phone or other wireless programmable appliance, where the application queries the device, measures the power of the response signal from the device, and commands the phone to alert the user if the measured power is less than a predetermined level.

In a preferred embodiment, the radio chip is a ULP Bluetooth chip and the device radio chip follows Bluetooth communications protocol. In a particular embodiment the alert includes the cell phone ringing or vibrating. In another embodiment, the distance can be determined by the user.

### BRIEF DESCRIPTION OF THE DRAWINGS

The invention will be better understood by referring to the following Figures:

FIG. 1 is a schematic showing what is included on the device.

FIG. 2 is a flow chart illustrating the operation of the program installed on the device.

FIG. 3 is a flow chart illustrating the operation of the software on the phone.

FIG. 4 is a block diagram illustrating the two components of the system.

FIG. 5 is a flowchart outlining a specific implementation of the invention.

### DETAILED DESCRIPTION OF THE INVENTION

It is an object of the present invention to provide an apparatus and method for preventing the loss of Mobile Phone, Wallet, Keys, and other high valued items.

Existing approaches to loss prevention based on wireless technology, and in particular Bluetooth protocol, exist. These systems rely on tagging devices with some sort of wireless device, and employing a separate wireless tracking unit to keep track of the tagged items. Such systems require a separate wireless device, which needs to have the communications capability, programmability and battery life required to function in a usable manner. The inventors have realized that most people carry smart cell phones and the world is moving toward more and more people having such phones. Thus the inventors have conceived of a loss protection system where the phone is the tracking unit, thereby eliminating the need for a separate unit. Smart phones already have relatively powerful wireless capability, including Bluetooth in most cases, have programmable controllers that can run third party software, and have long-life battery systems. Thus the phone can be programmed to serve as the tracking unit, in a symmetrical fashion, such that when any one of the tracked items is moving away from the other items, including the phone, the user can be alerted.

An exemplary system is described herein, for purposes of disclosure of a working example of the invention. It is to be understood that variations on the described system, such as other wireless protocols, or using other common wireless, programmable devices such as PDA's, will occur to those skilled in the art. The broad invention, as claimed is intended to such variations.

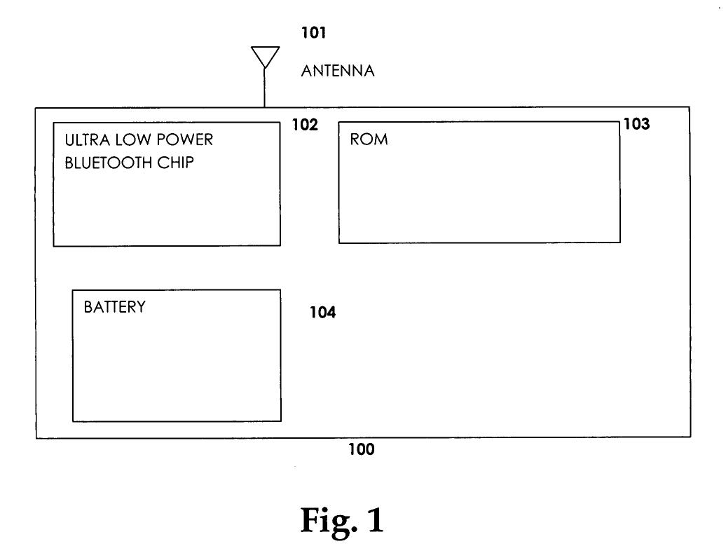

A small device containing a ULP Bluetooth transceiver capable of using ULP Bluetooth communication protocol, or other suitable wireless standard, as in FIG. 1 is attached to the item the user desires to protect. The device is powered by a small battery and can comfortably fit inside a wallet or easily attach to keys, rings, glasses, bracelets, belts, watches, backpacks, clothing, and purses. A mobile phone capable of communicating with Bluetooth devices runs software that pings the device. Once the device receives the ping signal sent from the phone, the device replies with a signal back. The software on the phone measures the power of the signal received and calculates the distance the device is separated from the phone. If the device and mobile phone are separated by more than a user selected distance, the phone will alert the user that the device is outside the user-defined range. A preferred detailed embodiment of the present invention will be described herein below with reference to the accompanying drawings. Some time increments, such as wait or sleep times will depend on system configuration and will be apparent to one skilled in the art. The times will be denoted by “x” or “small amount of time” in the following description.

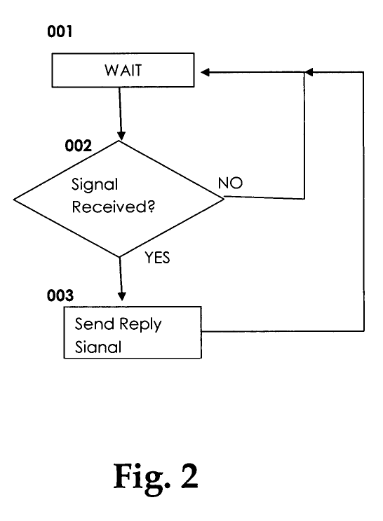

FIG. 1 is a block diagram of the device. The device preferably contains a ULP Bluetooth radio 102, ROM 103, antenna 101, and a battery 104. The ULP Bluetooth radio 102 is preferably a ULP enabled integrated circuit (IC) that is used to communicate to the corresponding radio on the mobile phone. The device is powered by a small battery 104 such as a button cell battery. The device has a ROM 103 used to store the program described in FIG. 2. The antenna is included in the ULP IC.

FIG. 2 is a flow chart illustrating the program running on the device. The device is initially in the Wait state 201. The wait state sets the Radio in a state where the power usage is minimum. If a signal is received 202, the program enables the radio to send a reply message 203 to the phone. If the device does not receive a signal, the device remains in the wait state 201.

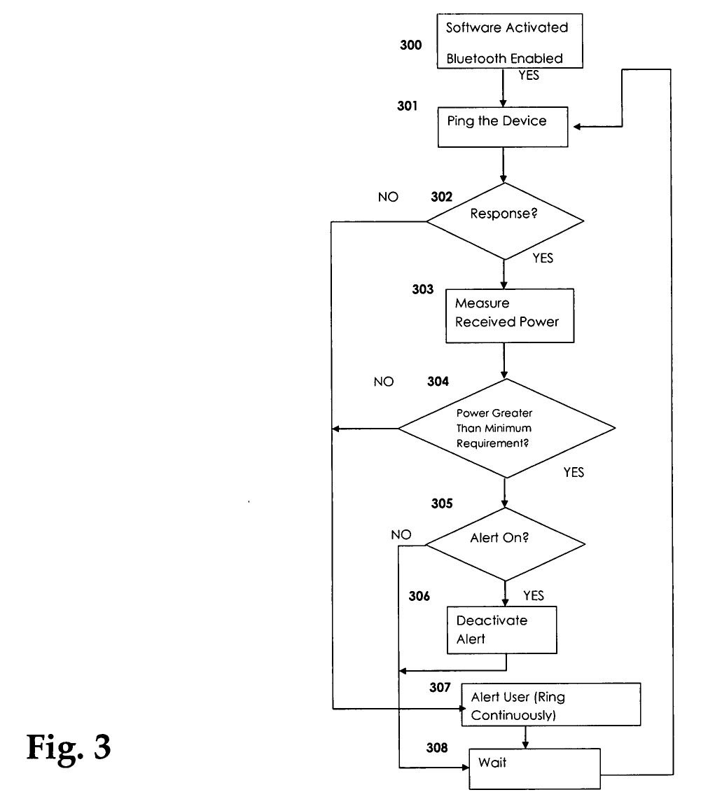

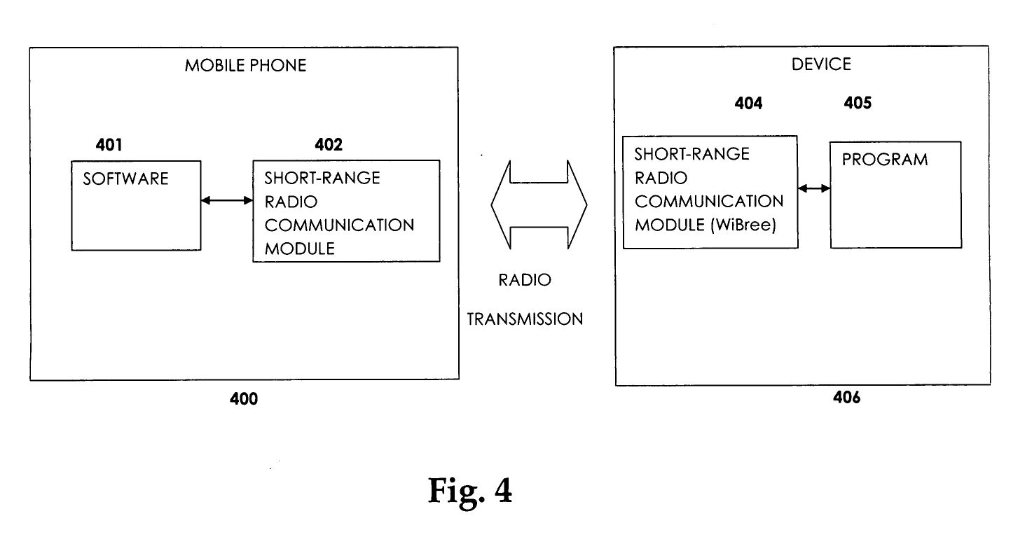

FIG. 4 is a block diagram illustrating the communication between the device and phone. The Mobile phone 400 runs software 401 that runs according to the flowchart shown in FIG. 3. The mobile phone uses its corresponding radio 402, typically not the main cellular radio, to communicate with the device 406. Upon detecting a communication from the master unit, the slave unit running a small program 405, uses its radio 404 to reply back to the master unit.

FIG. 3 is a flowchart that illustrates the process of determining whether to alert the user. The process begins with the software being enabled 300 on the mobile phone. The phone then uses its radio to ping 301 the device.

The mobile phone then detects whether there is a response signal 302 sent from the device. If there is no response signal, the mobile phone will proceed to alert the user via sound, visuals, and vibrating 307.

If there is a response, the phone measures the power received 303 and then proceeds to determine if the power is above a level 304 that has been defined by the user. If the power of the response signal is below or equal to the user defined level, the user will be alerted 307.

If the power of the response signal is above the user defined level, the phone proceeds to check whether the alert is on 305. If the alert is on, the alert is deactivate 306 then the phone waits 308 to conserve power and then after a small amount of time, typically dependent on the exact system configuration, the process is started once again by pinging the device 301.

If the alert is off, the phone goes to a wait state 308 and then after a small amount of time, depending on the particular system configuration, the process is started once again by pinging the device 301.

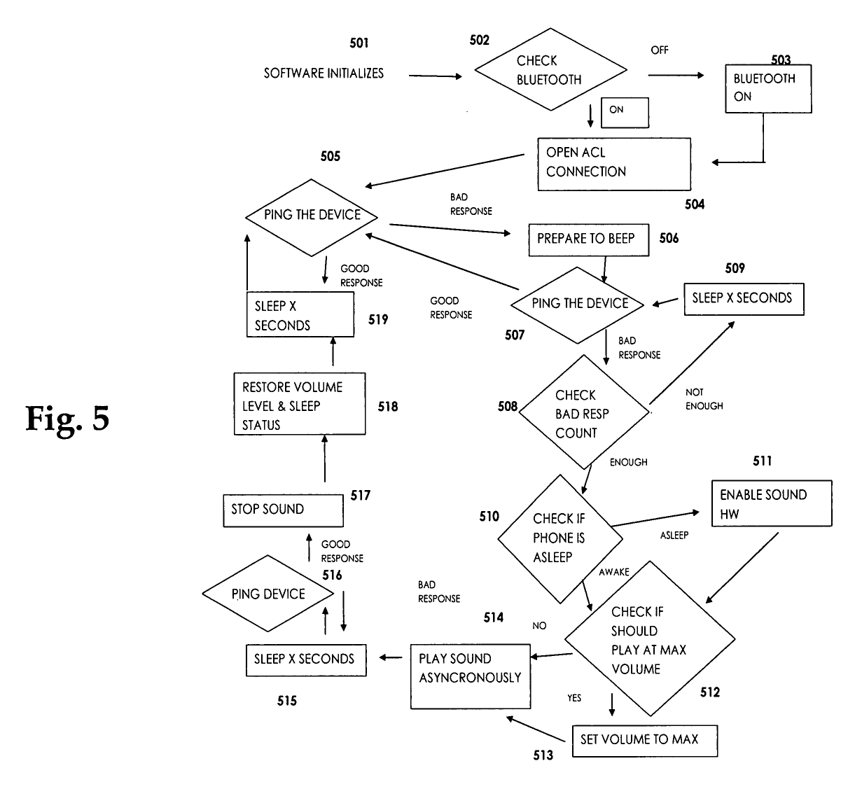

FIG. 5 is a flowchart that specifies a specific implementation of the process outlined in FIG. 3. The implementation begins with the software initializing 501 on the phone. The program on the device is already actively running and waiting for a connection from the phone. Once the software is activated, the software checks to see if the phone's bluetooth is active 502. If the phone's bluetooth is off, the software activates the bluetooth function on the phone 503. The software then opens an Asynchronous Connection Link (ACL) 504 with the device. If the phone's bluetooth is active 502, the software skips to opening an ACL connection with the device 504.

The software then uses the phone's bluetooth to ping the device 505. If the power of the response signal is “good”, above a user specified level, the phone sleeps x seconds, a system dependent number, 519. After sleeping, the phone once again pings the device 505 and checks the response. As long as the device's response is “good”, the software will enter a loop of pinging the device 505, and sleeping for x seconds 519.

If the software pings the device 505, and the power of the response signal from the device is “bad”, below a certain level, the software prepares to beep 506. The software once again pings the device 507, if the response is “good”, the software pings the device 505 again. If the response is “good”, the software sleeps for x seconds, a number that may vary from system to system, 519. If the response is “bad” after the device is pinged 505, the software once again prepares to beep and returns to the checking process described previously.

If the response is “bad” after the software pings the device 507, the software checks the number of “bad” responses that have occurred 508. If the “bad response count” is not enough, the software sleeps for x seconds 509 and then pings the device again 507. If the “bad response account” is enough, the software proceeds to check if the phone is in sleep mode 510.

If the phone is in sleep mode, the software enables the sound hardware on the phone 511 then checks if the phone should play the alert sound at full volume 512. If the phone is awake, the software skips enabling the sound hardware and proceeds to checking whether to play the alert sound at maximum volume 512.

If the user has previously indicated to play alert at maximum volume, the software sets the phone's volume to max 513 and then plays the alert asynchronously 514. If the user has not selected the alert to play at maximum volume, the software proceeds to play the alert sound 514. The alert is played asynchronously with the software such that other functions on the phone can be running while the alert is on.

The software sleeps for x seconds 515 and then pings the device 516. If the response is “bad”, the software sleeps for x seconds 515 and the process is repeated. If the ping response 516 is “good”, the software stops the alert 517, restores the previous volume level and sleep status 518, then sleeps for x seconds 519. The entire process, beginning with pinging the device 505 is started over.

It is envisioned that a user will preferably download the software install package from the internet and install it onto their phone although other means are possible. Once installed the user will preferably have an easily accessible button on their home screen allowing him to activate or disable the program or to open the settings dialog. From the settings dialog the user will be able to choose any sound file located on their phone for the software to play (the default will just be a beep). From the settings screen the user will also be able to set the volume that the sound should be played at (if the user wants the volume to be different from the ring volume) and modify the address of the external Bluetooth device. There will also preferably be an icon showing the status of the device (if it is enabled and working, or disabled).

Once the user activates the program, a service will be started on the phone running in the background. The service will start by creating an asynchronous connectionless link (ACL) with the external Bluetooth device (using its address from the settings dialog). This type of connection is used because it has all the functionality needed and uses less power than a full Bluetooth connection. Once connected the software will periodically (time to be determined from testing) query the device for its signal strength (the signal strength function is a standard function included in Bluetooth APIs). Once the signal has become weaker than a certain level for a given amount of time (signal strength and time to be determined from testing), the software on the phone will play the sound given in the settings dialog at the volume given in the settings dialog (looping if necessary) until the signal strength raises back above the given value or the user turns off the sound. This process will continue to occur until the software is disabled.

The external Bluetooth device will use the standard Bluetooth stack. It will have a “discovery” mode that will allow the phone to discover the address of the device and record it to the settings dialog, but after the setup is done it will not have a full Bluetooth connection with the phone. When the device is on and in “normal” mode (not in “discovery” mode), it will have the Bluetooth radio enabled allowing ACL connections, but it will not be discoverable nor will it have a full Bluetooth connection with any device (this will reduce power consumption).

It is desirable that this software makes a minimal impact on the power consumption of the phone. In order to do this the application will preferably run as a background service still allowing the phone to go to sleep, and only use minimal CPU and Bluetooth (when the device sleeps the CPU and Bluetooth by default do not actually power down, and the application will take advantage of this) cycles while letting the rest of the device to power down. When the software needs to play a sound, it will power up the speaker on the device and play the sound, then once it is done it will power back down the speaker to its previous “sleep” power level.

We claim:

1. a system for preventing loss of personal belongings comprising;
a device comprising of a radio chip, battery, and program storage,
an application adapted to execute on the device, wherein the application receives queries over the radio and responds; and,
an application adapted to execute on a wireless, programmable appliance, wherein the application queries the device, measures the power of the response signal from the device, commands the phone to alert the user if the measured power is less than a predetermined level.

2. The system of claim 1, wherein the radio chip is a ULP Bluetooth chip.

3. The system of claim 1 wherein the appliance is cell phone.

4. The system of claim 2, wherein the radio follows ULP Bluetooth communications protocol.

5. The system of claim 3, wherein said alert includes the cell phone ringing or vibrating.

6. The system of claim 1, wherein the distance can be determined by a user.
